(19) United States
(12) Patent Application Publication
(10) Pub. No.: US 2014/0079967 A1
(43) Pub. Date: Mar. 20, 2014

(54) SOLID SECONDARY BATTERY SYSTEM

(71) Applicants: Masashi Kodama, Susono-shi (JP); Shigenori Hama, Suntou-gun (JP); Takamasa Ohtomo, Susono-shi (JP)

(72) Inventors: Masashi Kodama, Susono-shi (JP); Shigenori Hama, Suntou-gun (JP); Takamasa Ohtomo, Susono-shi (JP)

(73) Assignee: TOYOTA JIDOSHA KABUSHIKI KAISHA, Toyota-shi, Aichi (JP)

(21) Appl. No.: 14/008,623

(22) PCT Filed: Jun. 10, 2011
(86) PCT No.: PCT/JP2011/063367

§ 371 Date: Sep. 30, 2013

(51) Int. Cl. H01M 10/50

(52) U.S. Cl. CPC H01M 10/502
USPC 429/62; 429/120; 429/61

(57) ABSTRACT

A solid secondary battery system includes a solid secondary battery including a positive electrode active material layer, a negative electrode active material layer and a solid electrolyte layer formed between the positive electrode active material layer and the negative electrode active material layer; a heater for warming the solid secondary battery; an over-discharge process unit configured to perform over-discharge process of the solid secondary battery; and a control unit configured to warm the solid secondary battery by means of the heater and/or to make the over-discharge process unit perform the over-discharge process of the solid secondary battery after the warming.

### TECHNICAL FIELD

The present invention relates to a solid secondary battery system capable of recovering deteriorated output performance thereof.

### BACKGROUND TECHNIQUE

Along with a rapid spread of information relevant apparatuses and communication apparatuses such as a personal computer, a video camera and a portable telephone in recent years, the development of a battery to be utilized as a power source thereof has been emphasized. Also in the automobile industry, the development of a high-output and high-capacity battery for an electric automobile or a hybrid automobile has been advanced. A lithium battery has been presently noticed from the viewpoint of a high energy density among various kinds of batteries.

Since liquid electrolyte containing a flammable organic solvent is used for a presently commercialized lithium battery, it is necessary to install a safety device for restraining temperature rise during a short circuit and to improve the structure and the material for preventing the short circuit. On the contrary, a lithium solid secondary battery all-solidified by replacing the liquid electrolyte with a solid electrolyte layer is considered to have an advantage of the simplification of the safety device and to be excellent in production cost and productivity because it does not need any flammable organic solvent therein.

A secondary battery can be repeatedly charged and discharged, but it is also known that the battery performance thereof could deteriorate through over-discharge process. Thus, a normal secondary battery has a structure for measuring the voltage of the battery during the discharge in order to stop the discharge at a predetermined voltage. In the meantime, Patent Reference-1 discloses a battery module which does not have any over-discharge protecting means for preventing the over-discharge of the lithium secondary battery, and Patent Reference-2 discloses an electrical apparatus which does not have any over-discharge protecting means for preventing the over-discharge of the lithium secondary battery.

### CITATION LIST

### Patent Reference

Patent Reference-1: Japanese Patent Application Laid-open under No. 2010-225581

Patent Reference-2: Japanese Patent Application Laid-open under No. 2010-225582

### DISCLOSURE OF INVENTION

### Problem to be Solved by the Invention

A solid secondary battery has a defect that increase of the internal resistance thereof due to repeats of charge and discharge could lead to deterioration of the output performance thereof. A solid secondary battery has another defect that increase of the internal resistance thereof due to high temperature (e.g., 60° C.) preservation could lead to deterioration of the output performance thereof. Furthermore, the recovery of the deteriorated output performance is generally difficult. The present invention has been achieved in order to solve the above problem. It is a main object of this invention to provide a solid secondary battery system capable of recovering the deteriorated output performance.

### Means for Solving the Problem

As a result of hard work by the inventors in order to achieve the above-mentioned object, a knowledge is obtained that positively (purposely) performing the over-discharge process is effective for the recovery of the deteriorated output performance contrary to expectations. The present invention is based on the above-mentioned knowledge.

According to the present invention, a solid secondary battery system comprises a solid secondary battery including a positive electrode active material layer, a negative electrode active material layer and a solid electrolyte layer formed between the positive electrode active material layer and the negative electrode active material layer; a heater for warming the solid secondary battery; an over-discharge process unit configured to perform over-discharge process of the solid secondary battery; and a control unit configured to warm the solid secondary battery by means of the heater and/or to make the over-discharge process unit perform the over-discharge process of the solid secondary battery after the warming.

The above solid secondary battery system includes a solid secondary battery, a heater, an over-discharge process unit and a control unit. The solid secondary battery includes a positive electrode active material layer, a negative electrode active material layer and a solid electrolyte layer formed between the positive electrode active material layer and the negative electrode active material layer. The heater warms the solid secondary battery. The over-discharge process unit performs the over-discharge process of the solid secondary battery. The term “over-discharge process” herein indicates process for discharging the solid secondary battery until the voltage thereof is equal to or smaller than a predetermined voltage such as the rated lower-limit voltage, and/or, process for keeping the voltage after the discharge. In particular, examples of the over-discharge process include process for making an external short circuit. The term “external short circuit” herein indicates short-circuiting the positive electrode active material layer and the negative electrode active material layer of the solid secondary battery via an external circuit. Examples of the over-discharge process includes discharging the battery until the voltage thereof is 0V and discharging the battery so that the polarity inversion thereof occurs (i.e., the voltage becomes negative). For example, the control unit is an ECU (Electronic Control Unit). The control unit warms the solid secondary battery by means of the heater and/or makes the over-discharge process unit perform the over-discharge process of the solid secondary battery after the warming.

By warming the solid secondary battery through the over-discharge process to adjust the temperature thereof, the solid secondary battery system can efficiently and effectively recover the deteriorated output performance of the solid secondary battery.

In a manner of the solid secondary battery system, the heater is connected to the solid secondary battery and warms the solid secondary battery by using electricity of the solid secondary battery. In this manner, the solid secondary battery system can warm the solid secondary battery by using the electricity remaining in the solid secondary battery without having a power source for driving the heater to make the battery temperature become a temperature suitable for the over-discharge process.

In another manner of the solid secondary battery system, the heater functions as the over-discharge process unit, and the control unit drives the heater to let the heater consume the electricity of the solid secondary battery if voltage of the solid secondary battery becomes smaller than a predetermined voltage. The term “predetermined voltage” herein indicates the lower limit of the voltage for steadily supplying the electricity, for example. Concretely, it is determined in advance through experimental trials. By letting the heater function as the over-discharge process unit thereby to consume the remaining electricity of the solid secondary battery, the solid secondary battery system can effectively use its energy. Furthermore, the solid secondary battery system does not have to have any resistor for the over-discharge process thereby to achieve space saving thereof.

In another manner of the solid secondary battery system, the control unit lets the heater consume the electricity of the solid secondary battery, and makes an external short circuit of the solid secondary battery if the heater cease to work. In this manner, the solid secondary battery system can make the external short circuit after adequately lowering the voltage of the solid secondary battery thereby to safely and effectively recover the deteriorated output performance of the solid secondary battery.

### Advantageous Effects of Invention

The solid secondary battery system of the present invention produces an effect that the deteriorated output performance due to the charge and the discharge can be effectively recovered.

### BRIEF DESCRIPTION OF THE DRAWINGS

FIG. 1 is an example of a schematic configuration of the solid secondary battery system according to the embodiment.

FIG. 2 is a schematic cross-section diagram illustrating an example of the solid secondary battery according to the embodiment.

FIG. 3 shows a transparent view of the solid secondary battery according to the embodiment.

FIG. 4 shows an overview of the heaters according to the embodiment.

FIG. 5 is an example of a flowchart indicating a procedure of the process according to the embodiment.

FIG. 6 is an example of a schematic configuration of the solid secondary battery system according to the modification.

### DETAILED DESCRIPTION OF THE PREFERRED EMBODIMENTS

A preferred embodiment of the present invention will be explained hereinafter with reference to the drawings.

[Solid Secondary Battery System]

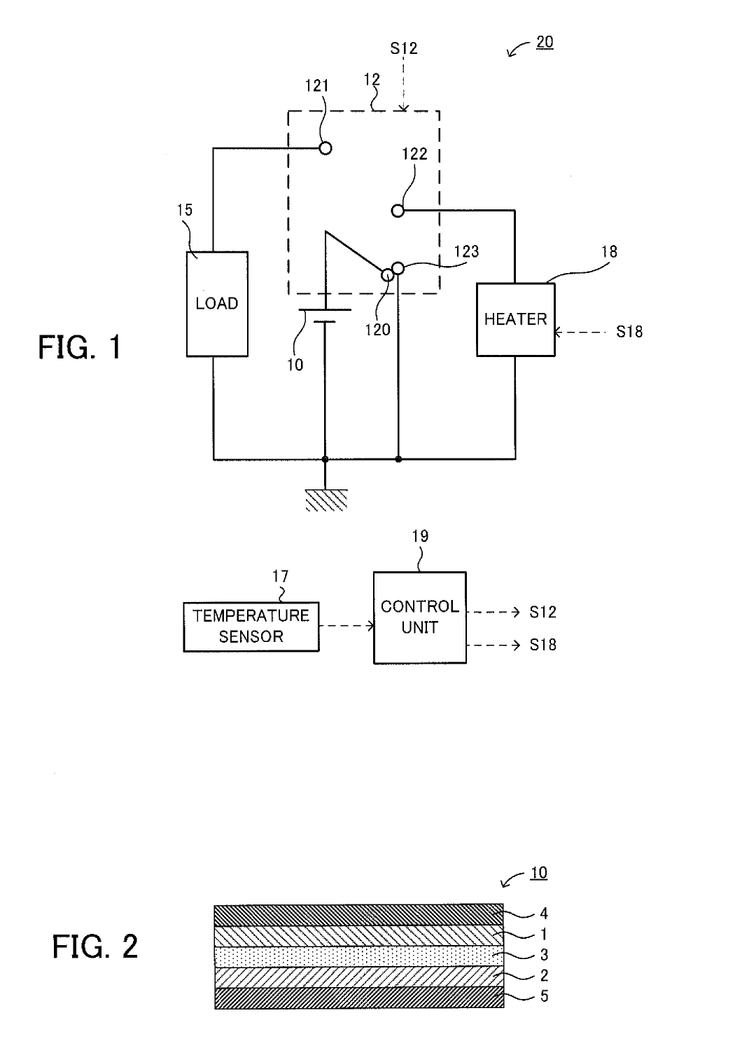

First, the solid secondary battery system according to the embodiment will be described below. FIG. 1 shows a schematic configuration of the solid secondary battery system 20. The solid secondary battery system 20 shown in FIG. 1 includes a solid secondary battery 10, a switching unit 12, a load 15 such as a motor and an electric component, a temperature sensor 17, a heater 18 and a control unit 19.

The solid secondary battery 10 includes a positive electrode active material layer, a negative electrode active material layer and a solid electrolyte layer formed between the positive electrode active material layer and the negative electrode active material layer. The concrete description will be given of the configuration of the solid secondary battery 10 with reference to FIG. 2. FIG. 2 is a schematic cross-section diagram illustrating an example of the solid secondary battery 10 according to the embodiment. The solid secondary battery 10 shown in FIG. 2 includes a positive electrode active material layer 1, a negative electrode active material layer 2, a solid electrolyte layer 3 formed between the positive electrode active material layer 1 and the negative electrode active material layer 2, a positive electrode current collector 4 for performing current collecting of the positive electrode active material layer 1 and a negative electrode current collector 5 for performing current collecting of the negative electrode active material layer 2.

Other components of the solid secondary battery system 20 will be described with reference to FIG. 1 again. The switching unit 12 includes a common terminal 120, a first optional terminal 121, a second optional terminal 122, and a third optional terminal 123. On the basis of the control signal S12 sent from the control unit 19, the switching unit 12 connects the common terminal 120 to one of the first optional terminal 121, the second optional terminal 122 and the third optional terminal 123. As described later, the common terminal 120 of the switching unit 12 is connected to the first optional terminal 121 at normal times when over-discharge process is not performed whereas the common terminal 120 is connected to either the second optional terminal 122 or the third optional terminal 123 at the time of the over-discharge process. If the common terminal 120 of the switching unit 12 is connected to the second optional terminal 122, the heater 18 is driven by use of the electric power remaining in the solid secondary battery 10 thereby to warm up the solid secondary battery 10. In contrast, if the common terminal 120 is connected to the third optional terminal 123, a closed circuit including the solid secondary battery 10 is formed and the external short circuit with respect to the solid secondary battery 10 is performed.

The heater 18 is an electrically driven heater provided on the outside of the solid secondary battery 10. For example, the heater 18 is a mantle heater with electrically heated wires. If the common terminal 120 is connected to the third optional terminal 123, on the basis of the control signal S18 sent from the control unit 19, the heater 18 produces heat by use of the electric power supplied from the solid secondary battery 10 thereby to warm up the solid secondary battery 10. Preferably, the heater 18 is provided adjacent to a side of the solid secondary battery 10, and a lagging material such as a heat insulator is provided on the side of the heater 18 opposite to the solid secondary battery 10. In such a configuration, the heater 18 has resistance to heat loss. A detailed description relating to the control of warming the solid secondary battery 10 by means of the heater 18 will be given later with reference to FIG. 4. The temperature sensor 17 is fixed in a state that the temperature sensor 17 is inserted between the heater 18 and the solid secondary battery 10 for example, and detects the temperature of the solid secondary battery 10. The temperature sensor 17 is a sensor such as a thermocouple and a bimetal, and sends the detection signal indicating the detected temperature to the control unit 19.

The control unit 19 is an ECU (Electronic Control Unit) for example, and controls the whole solid secondary battery system 20. In particular, the control unit 19 sends the control signal S12 to the switching unit 12 thereby to switch the state of the common terminal 120. The control unit 19 also sends the control signal S18 to the heater 18 thereby to control the temperature of the heater 18.

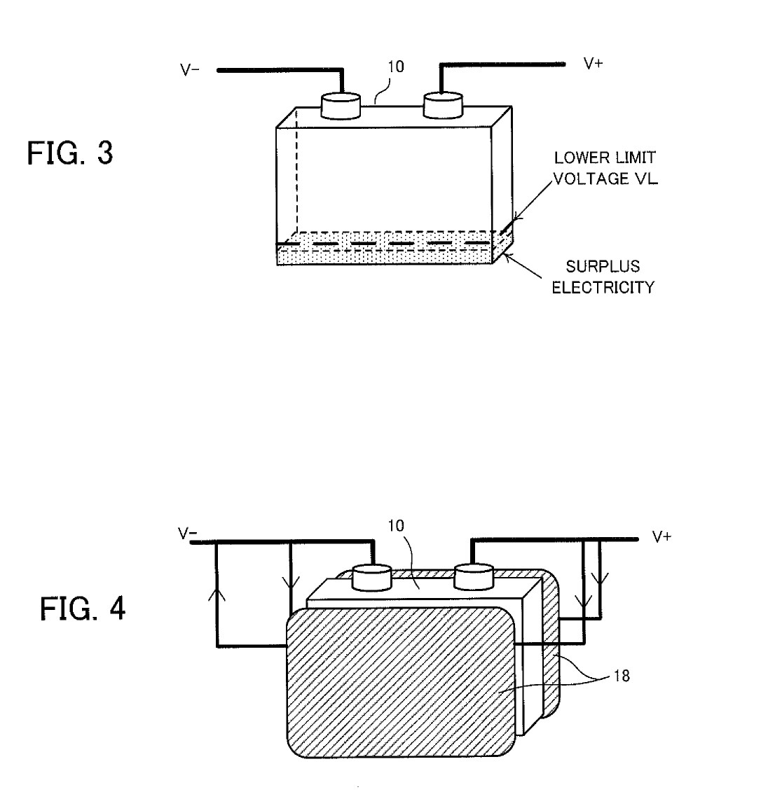

A description will be given of the warming of the solid secondary battery 10 by means of the heater 18 with reference to FIGS. 3 and 4.

FIG. 3 shows a transparent view of the deteriorated solid secondary battery 10 before the process by the over-discharge process unit 11. The term “lower limit voltage VL” herein indicates the lower limit of the voltage with which the solid secondary battery 10 can stably output the electric power to the load 15. Concretely, the lower limit voltage VL is a predetermined value determined in advance through experimental trials. The lower limit voltage VL is an example of the term “predetermined voltage” according to the present invention. As shown in FIG. 3, in the solid secondary battery 10, there remains electricity (referred to as “surplus electricity”) smaller than the lower limit voltage VL. The above-mentioned surplus electricity cannot be used for the load 15 since it is smaller than the lower limit voltage VL.

FIG. 4 shows an overview of the process of warming the solid secondary battery 10 by means of heaters 18. The heaters 18 shown in FIG. 4 are provided to be adjacent to the both sides of the solid secondary battery 10. Preferably, a lagging material (not shown) such as a heat insulator is provided on the side of the heater 18 opposite to the solid secondary battery 10 in order to enhance the effect of the warming.

As shown in FIG. 4, when the common terminal 120 shown in FIG. 1 is connected to the second optional terminal 122, the heater 18 is driven by receiving the supply of the surplus electricity of the solid secondary battery 10. Concretely, the control unit 19 controls the temperature of the heater 18 by receiving the detection signal S17 sent from the temperature sensor 17. Thereby, the heater 18 functions as a resistor or a resistance for warming up the solid secondary battery 10 and for consuming the surplus electricity. Thus, as described later, there is no necessity to provide any additional resistor for the over-discharge process. As a result, it is possible to achieve efficient use of the electric power and space-saving.

Preferably, the control unit 19 controls the heater 18 so that the temperature of the solid secondary battery 10 is within a range of 30° C. to 80° C. More preferably, the control unit 19 controls the heater 18 so that the battery temperature becomes 80° C. Thereby, the control unit 19 promotes elimination of the capsule at the interface between the positive electrode active material layer 1 and the solid electrolyte layer 3 through the over-discharge process thereby to enhance the output performance of the solid secondary battery 10.

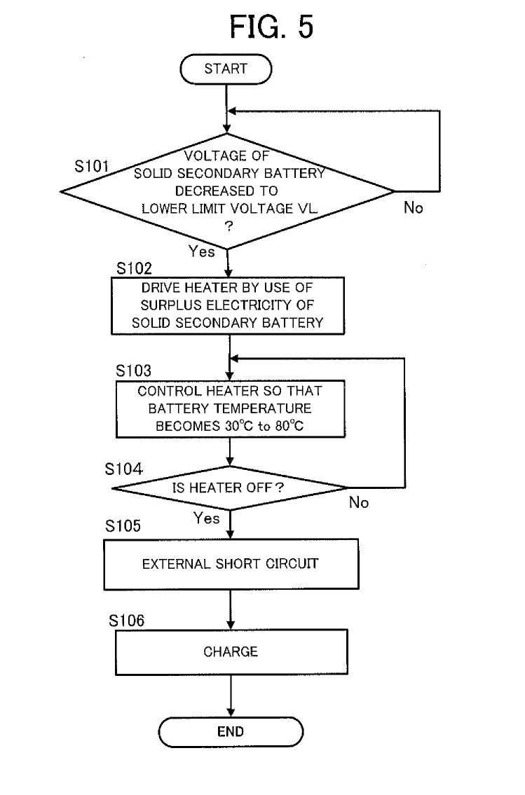

FIG. 5 is a flowchart indicating a procedure of the process executed by the control unit 19 according to the embodiment. The flow chart shown in FIG. 5 is repeatedly executed by the control unit 19 in a predetermined cycle. Hereinafter, it is assumed that the common terminal 120 of the switching unit 12 is connected to the first optional terminal 121 at the start time of the flowchart.

First, the control unit 19 determines whether or not the voltage of the solid secondary battery 10 has decreased to the lower limit voltage VL (step S101). If the voltage of the solid secondary battery 10 has not decreased to the lower limit voltage VL yet (step S101; No), the control unit 19 determines that the load 15 can be driven by use of the electricity remaining in the solid secondary battery 10 and uses the electricity remaining in the solid secondary battery 10 for the load 15.

If the voltage of the solid secondary battery 10 has already decreased to the lower limit voltage VL (step S101; Yes), the control unit 19 drives the heater 18 by use of the surplus electricity of the solid secondary battery 10 (step S102). Concretely, the control unit 19 sends the control signal S12 to the switching unit 12 thereby to connect the common terminal 120 to the second optional terminal 122, and sends the control signal S18 to the heater 18 thereby to drive the heater 18.

Next, on the basis of the detection signal S17 supplied from the temperature sensor 17, the control unit 19 controls the heater 18 so that the temperature of the solid secondary battery 10 is within a range of 30° C. to 80° C. (step S103). Thereby, while performing the over-discharge process for making the voltage of the solid secondary battery 10 approximate 0V, the control unit 19 can perform the warming-up of the solid secondary battery 10 in order to effectively recover the deteriorated output performance of the solid secondary battery 10 through the over-discharge process.

Then, the control unit 19 determines whether or not the heater 18 is off (step S104). If the control unit 19 determines that the heater 18 is not off (step S104; No), the control unit 19 keeps driving the heater 18 thereby to make the voltage of the solid secondary battery 10 approximate 0V while warming up the solid secondary battery 10.

If the heater 18 is off (step S104; Yes), the control unit 19 determines that the surplus electricity of the solid secondary battery 10 has already been almost consumed and that the voltage of the solid secondary battery 10 is almost 0V. In this case, the control unit 19 makes the external short circuit of the solid secondary battery 10 (step S105). In particular, the control unit 19 sends the control signal 12 to the switching unit 12 thereby to connect the common terminal 120 to the third optional terminal 123. It is noted that deterioration of the solid secondary battery 10 due to the external short circuit does not occur since the surplus electricity of the solid secondary battery 10 has already been almost consumed by the heater 18. Preferably, the control unit 19 keeps the voltage (0V) of the solid secondary battery 10 for more than ten hours. Thereafter, the control unit 19 charges the solid secondary battery 10 through the switching process for connecting the solid secondary battery 10 to a battery charger (step S106).

In this way, by executing the process of the flowchart shown in FIG. 5 at regular intervals, the control unit 19 can warm up the solid secondary battery 10 so that the temperature of the solid secondary battery 10 becomes an appropriate temperature for the over-discharge process while executing the over-discharge process of the heater 18. Thus, the control unit 19 can effectively recover the deteriorated output performance of the solid secondary battery 10 thereby to extend the life cycle of the solid secondary battery 10.

Hereinafter, a supplemental explanation of the effects of the solid secondary battery system 20 according to the embodiment will be described.

The solid secondary battery system 20 can let the solid secondary battery 10 be in an over-discharged state. Thereby, it is possible to decrease the internal resistance and to recover the output performance. Thus, the extension of the life cycle of the solid secondary battery 10 can be achieved. Conventionally, over-discharging is considered to lead to the deterioration of the battery performance. Thus, in a normal solid secondary battery, there is provided an over-discharge protection unit for safeguarding against the over-discharge. In contrast, according to the present invention, letting the solid secondary battery 10 whose charge cycle is deteriorated be in the over-discharged state enables the decrease of the internal resistance and the recovery of the output performance.

Next, a description will be given of the effects of the process of warming up the solid secondary battery 10 by means of heater 18. In case of letting the solid secondary battery 10 be in the over-discharged state by discharging the electricity of the solid secondary battery 10 to 0V, the resistance of the solid secondary battery 10 becomes smaller and the output performance can be enhanced. This is considered due to the elimination of the capsule at the interface between the positive electrode active material layer 1 and the solid electrolyte layer 3 by letting the solid secondary battery 10 be in the over-discharged state. In addition, the elimination of the capsule at the interface between the positive electrode active material layer 1 and the solid electrolyte layer 3 can be promoted by executing the over-discharge process of the solid secondary battery 10 in a state that the temperature of the solid secondary battery 10 is at least a predetermined temperature. In this case, the output performance of the solid secondary battery 10 is greatly enhanced. In addition, according to the embodiment, the surplus electricity to be discharged from the solid secondary battery 10 is used as electric power for driving the heater 18. Thus, according to the embodiment, it is possible to effectively use energy, and since the heater 18 functions as a resistance, there is no necessity to provide a variable resistance for consuming the surplus electricity of the solid secondary battery 10. Thus, the space-saving can be achieved.

[Modification]

The first to the third modifications of the embodiment to which the present invention can be preferably applied will be described below. Each of the modifications can be applied to the above-mentioned embodiment in combination.

(1) First Modification

According to the above-mentioned explanation, the control unit 19 performs the over-discharge process for consuming the surplus electricity by letting the heater 18 function as a resistance while warming up the solid secondary battery 10 by means of the heater 18. Instead of this, the control unit 19 may perform the over-discharge process for consuming the surplus electricity after the warming-up of the solid secondary battery 10 by means of heater 18.

For example, in this case, the control unit 19 starts to warm the solid secondary battery 10 by means of the heater 18 when the voltage of the solid secondary battery 10 has fallen to a predetermined voltage larger than the lower limit voltage VL. In this case, as with the above-mentioned embodiment, the control unit 19 controls the heater 18 so that the temperature of the solid secondary battery 10 is within a range of 30° C. to 80° C. If the voltage of the solid secondary battery 10 has fallen to the lower limit voltage VL, the control unit 19 starts the over-discharge process. In this case, as described later in the second modification, a resistance other than the heater 18 may consume the surplus electricity.

(2) Second Modification

According to the above-mentioned explanation, in the over-discharge process, the heater 18 consumes the surplus electricity. However, the process to which the present invention can be applied is not limited to the process.

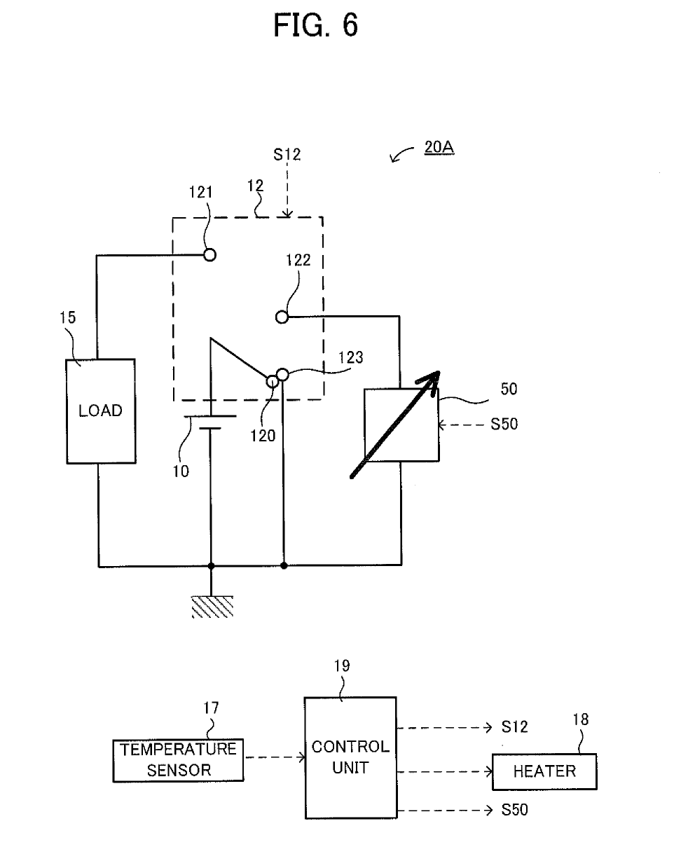

FIG. 6 shows a schematic configuration of the solid secondary battery system 20A according to the second modification. The solid secondary battery system 20A includes a variable resistance 50 capable of changing its resistance (load). The variable resistance 50 is connected to the second optional terminal 122. The heater 18 is provided to be adjacent to the solid secondary battery 10, and on the basis of the detection signal S18 sent from the control unit 19, the heater 18 is driven by use of electricity supplied from a power source other than the solid secondary battery 10, for example.

When the control unit 19 determines that the over-discharge process should be performed, the control unit 19 controls the heater 18 so that the temperature of the solid secondary battery 10 is within a range of 30° C. to 80° C. In addition, the control unit 19 sends the control signal S12 to the switching unit 12 thereby to connect the common terminal 120 to the second optional terminal 122 which is connected to the variable resistance 50. Thereby, the surplus electricity is consumed by the variable resistance 50. Thus, according to the second modification, while keeping the temperature of the solid secondary battery 10 at an appropriate temperature, the control unit 19 can also consume the surplus electricity of the solid secondary battery 10 so that the voltage thereof becomes 0V thereby to let the solid secondary battery 10 be in the over-discharge state.

Instead of this, the control unit 19 may let the heater 18 consume the surplus electricity of the solid secondary battery 10 at first, and after the heater 18 becomes power-off, the control unit 19 may let the variable resistance 50 consume the surplus electricity until the voltage of the solid secondary battery 10 becomes 0V.

(3) Third Modification

The mode of the over-discharge process is not limited to what is mentioned above. Instead of the above-mentioned example, the solid secondary battery system 20 may make the solid secondary battery 10 be in the over-discharged state through the process by a discharge device (discharge and charge device) or through the external short circuit. Preferably, in this case, the solid secondary battery system 20 alternates the discharging process until the voltage becomes a predetermined voltage (e.g., 0V) and the process for keeping the voltage. For example, in case of shifting the solid secondary battery 10 to the over-discharged state by a discharge device, it is preferable for the solid secondary battery system 20 to perform the constant-voltage discharge (CV discharge) as the above-mentioned process for keeping the voltage. On the other hand, in case of shifting the solid secondary battery 10 to the over-discharged state through the external short circuit, it is preferable for the solid secondary battery system 20 to keep the external short circuit as the above-mentioned process for keeping the voltage.

[Detail of Solid Secondary Battery]

Next, a detailed description will be given of the solid secondary battery according to the present invention. The solid secondary battery according to the present invention has at least a positive electrode active material layer, a solid electrolyte layer and a negative electrode active material layer, and normally has a positive electrode current collector and a negative electrode current collector in addition.

(1) Positive Electrode Active Material Layer

The positive electrode active material layer according to the present invention contains at least a positive electrode active material, and may further contain at least one of a solid electrolyte material, a conductive material and binder, as required. The type of the positive electrode active material is arbitrarily determined in accordance with the type of the solid secondary battery. For example, it may be an oxide active material or a sulfide active material. The positive electrode active material used for the lithium solid secondary battery may be a laminated positive electrode active material such as LiCoO₂, LiNiO₂, LiCo_{1/3}Ni_{1/3}Mn_{1/3}O₂, LiVO₂, and LiCrO₂; a spinel type positive electrode active material such as LiMn₂O₄, Li(Ni_{0.25}Mn_{0.75})₂O₄, LiCoMnO₄, and Li₂NiMn₃O₈; an olivine type positive electrode active material such as LiCoPO₄, LiMnPO₄, LiFePO₄; and a NASICON (Na Super Ionic Conductor) type positive electrode active material such as Li₃V₂P₃O₁₂.

Examples of the shape of the positive electrode active material include a particulate or a lamella. For example, the average particle diameter (D₅₀) of the positive electrode active material is preferably within a range of 1 nm to 100 μm, and is more preferably within a range of 10 nm to 30 um. The amount of the positive electrode active material contained in the positive electrode active material layer is not particularly limited, but is preferably within a range of 40% by weight to 99% by weight, for example.

The positive electrode active material layer may contain a solid electrolyte material. Addition of the solid electrolyte material enables enhancement of the ion conductivity of the positive electrode active material layer. The explanation of the solid electrolyte material will be given in the section “(3) Solid Electrolyte Layer”. The amount of the solid electrolyte material contained in the positive electrode active material layer is not particularly limited, but is preferably within a range of 10% by weight to 90% by weight, for example.

The positive electrode active material layer may contain a conductive material. Addition of the conductive material enables enhancement of the electron conductivity of the positive electrode active material layer. Examples of the conductive material include acetylene black, Ketjen Black and carbon fiber. Preferably, the positive electrode active material layer contains a binder. Thereby, a positive electrode active material layer with high flexibility can be obtained. Examples of the binder include a fluorine-containing binder such as PTFE and PVDF. The thickness of the positive electrode active material layer is preferably within a range of 0.1 μm to 1000 μm, and is more preferably within a range of 1 μm to 100 μm, for example.

(2) Negative Electrode Active Material Layer

The negative electrode active material layer according to the present invention contains at least a negative electrode active material, and may further contain at least one of a solid electrolyte material, a conductive material and a binder, as required. The type of the negative electrode active material is not particularly limited if it is capable of absorbing and discharging metal ions. Examples of the negative electrode active material include a carbon active material, an oxide active material, and a metal active material. Examples of the carbon active material include mesocarbon microbeads (MOMS), high orientation property graphite (HOPG), hard carbon and soft carbon. Examples of the oxide active material include Nb₂O₅, Li₄Ti₅O₁₂ and SiO. Examples of the metal active material include In, Al, Si and Sn.

Examples of the shape of the negative electrode active material include a particulate and a lamella. For example, the average particle diameter (D₅₀) of the negative electrode active material is preferably within a range of 1 nm to 100 μm, and is more preferably within a range of 10 nm to 30 μm. The amount of the negative electrode active material contained in the negative electrode active material layer is not particularly limited, but is preferably within a range of 40% by weight to 99% by weight, for example.

The negative electrode active material layer may contain a solid electrolyte material. Addition of solid electrolyte material enables enhancement of the ion conductivity of the negative electrode active material layer. The explanation of the solid electrolyte material will be given in the section “(3) Solid Electrolyte Layer”. The amount of the solid electrolyte material contained in the negative electrode active material layer is not particularly limited, but is preferably within a range of 10% by weight to 90% by weight, for example. The description of the conductive material and the binder used for the negative electrode active material layer herein will be omitted since they are the same as what is described in the prior section “(1) Positive Electrode Active Material Layer”. The thickness of the negative electrode active material layer is preferably within a range of 0.1 μm to 1000 μm, and is more preferably within a range of 1 μm to 100 μm, for example.

(3) Solid Electrolyte Layer

The solid electrolyte material layer according to the present invention contains at least a solid electrolyte material. For example, the solid electrolyte material may be an inorganic solid electrolyte material such as a sulfide solid electrolyte material, an oxide solid electrolyte material, a nitride solid electrolyte material and a halide solid electrolyte material. The sulfide solid electrolyte material is superior to the oxide solid electrolyte material in terms of high ion conductivity whereas the oxide solid electrolyte material is superior to the sulfide solid electrolyte material in terms of high chemical stability. The term “halide solid electrolyte material” herein indicates inorganic solid electrolyte material containing halogen.

The sulfide solid electrolyte material normally contains metallic elements (M) which become ions to conduct and sulfur (S). Examples of the metallic element include Li, Na, K, Mg and Ca, out of which Li is the best example. In particular, preferably, the sulfide solid electrolyte material contains Li, A (A is at least one selected from the group consisting of P, Si, Ge, Al and B) and S. The sulfide solid electrolyte material may contain halogen such as CL, Br and I. Containing halogen enables enhancement of the ion conductivity. The sulfide may also contain O. Containing O leads to enhancement of the chemical stability.

Examples of the sulfide solid electrolyte material having a Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—P₂S₅—LiI, Li₂S—B₂S₃, Li₂S—P₂S₅—ZₘSₙ (m and n are positive numbers. Z is one of Ge, Zn and Ga.), Li₂S—GeS₂, Li₂S—SiS₂—Li₃PO₄ and Li₂S—SiS₂—LiₓMO_{y} (x and y are positive numbers. M is one of P, Si, Ge, B, Al, Ga and In.). The above expression “Li₂S—P₂S₅” indicates a sulfide solid electrolyte material prepared by using raw material compositions including Li₂S and P₂S₅, and the same explanation can be applied to other similar expression.

Preferably, the sulfide solid electrolyte material does not substantially contain Li₂S, because this enables the sulfide solid electrolyte material to have a nigh chemical stability. Li₂S generates hydrogen sulfide by reacting with H₂O. For example, the larger the ratio of Li₂S to the raw material composition, the larger the remaining amount of Li₂S tends to be. It is possible to confirm the fact that the sulfide solid electrolyte material does not substantially contain Li₂S″ by use of X-ray diffraction. In particular, if the sulfide solid electrolyte material does not have the peak (2θ=27.0°, 31.2°, 44.8° and 53.1°) of Li₂S, it can be determined that the sulfide solid electrolyte material does not substantially contain Li₂S.

Preferably, the sulfide solid electrolyte material also does not substantially contain cross-linked sulfur, because this enables the sulfide solid electrolyte material to have a high chemical stability. The term “cross-linked sulfur” indicates a chemical compound composed of sulfide of the above-mentioned A reacting with the Li₂S. Examples of the cross-linked sulfur include cross-linked sulfur having a S₃P—S—PS₃ structure composed of Li₂S reacting with P₂3₅. This kind of the cross-linked sulfur is easy to react with H₂O and to generate hydrogen sulfide. It is possible to confirm the fact that “the sulfide solid electrolyte material does not substantially contain cross-linked sulfur” by measuring Raman spectrum. For example, in case of a Li₂S—P₂S₅-based sulfide solid electrolyte material, the peak of the S₃P—S—PS₃ structure normally appears at 402 cm⁻¹. Thus, it is preferred that the peak is not detected. The peak of PS₄³⁻ structure normally appears at 417 cm⁻¹. In the present invention, preferably, the intensity I₄₀₂ at 402 cm⁻¹ is smaller than the intensity I₄₁₇ at 417 cm⁻¹. More concretely, the intensity I₄₀₂ is preferably equal to or smaller than 70% of the intensity I₄₁₇, more preferably equal to or smaller than 50% thereof, and far more preferably equal to or smaller than 35% thereof, for example.

When the sulfide solid electrolyte material is prepared by using raw material compositions including Li₂S and P₂S₅, the ratio of the Li₂S to the sum of Li₂S and P₂S₅ is preferably within a range of 70 mol % to 80 mol %, more preferably within a range of 72 mol % to 78 mol %, and far more preferably within a range of 74 mol % to 76 mol %, for example. This enables the sulfide solid electrolyte material to have an ortho composition or other similar compositions, and also enables the sulfide solid electrolyte material to have a high chemical stability. The term ‘ortho” generally means an oxo acid having the highest degree of hydration among oxo acids obtained by hydrating the same oxide. In the present invention, a crystal composition of a sulfide having a largest amount of Li₂S added is referred to as the ortho composition. Li₃PS₄ corresponds to an ortho composition in Li₂S—P₂S₅-based solid electrolyte materials. In case of the Li₂S—P₂S₅-based sulfide solid electrolyte material, the ratio of Li₂S and P₂S₅ for obtaining an ortho composition is Li₂S:P₂S₅=75:25 on a molar basis. Even when Al₂S₃ or 2₂S₃ is used for the above-mentioned raw material composition instead of P₂S₅, a preferable range thereof is substantially the same range. Li₃AlS₃ corresponds to an ortho composition in Li₂S—Al₂S₃-based solid electrolyte materials, and Li₃BS₃ corresponds to an ortho composition in Li₂S—B₂S₃-based solid electrolyte materials.

When the sulfide solid electrolyte material is prepared by using raw material compositions including Li₂S and SiS₂, the ratio of the Li₂S to the sum of Li₂S and SiS₂ is preferably within a range of 60 mol % to 72 mol %, more preferably within a range of 62 mol % to 70 mol %, and far more preferably within a range of 64 mol % to 68 mol %, for example. This enables the sulfide solid electrolyte material to have an ortho composition or other similar compositions, and also enables the sulfide solid electrolyte material to have a high chemical stability. Li₄SiS₄ corresponds to an ortho composition in Li₂S—SiS₂-based solid electrolyte materials. In case of the Li₂S—SiS₂-based sulfide solid electrolyte material, the ratio of Li₂S and SiS₂ for obtaining an ortho composition is Li₂S:SiS₂=66.6:33.3 on a molar basis. Even when GeS₂ is used for the above-mentioned raw material composition instead of SiS₂, a preferable range thereof is substantially the same range. Li₄GeS₄ corresponds to an ortho composition in Li₂S-GeS₂-based solid electrolyte materials.

When the sulfide solid electrolyte material is prepared by using raw material compositions including LiX (X═Cl, Br, I), the ratio of the LiX is preferably within a range of 1 mol % to 60 mol %, more preferably within a range of 5 mol % to 50 mol %, and far more preferably within a range of 10 mol % to 40 mol %, for example . When the sulfide solid electrolyte material is prepared by using raw material compositions including Li₂O, the ratio of the Li₂O is preferably within a range of 1 mol % to 25 mol %, and more preferably within a range of 3 mol % to 15 mol %.

Examples of the sulfide solidelectrolytematerial includes a sulfide glass, a crystallized sulfide glass and a crystalline material obtained through the solid phase process. The sulfide glass can be obtained by performing Mechanical Milling (e.g., by ball mill) with respect to the raw material composition, for example. The crystallized sulfide glass can be obtained through heat treatment of a sulfide glass with a temperature equal to or higher than the crystallization temperature, for example. If the sulfide solid electrolyte material is an Li ion conductor, the degree of Li ion conductivity at an ordinary temperature is preferably equal to or greater than 1×10⁻⁵ S/cm, and more preferably equal to or greater than 1×10⁻⁴ S/cm, for example.

In contrast, examples of the oxide solid electrolyte material having a Li ion conductivity include a compound having a NASICON type structure. An example of the compound having a NASHICON type structure is a compound expressed by the following general expression “Li₁₋ₓAlₓGe₂₋ₓ (PO₄)₃ (0≦x≦2)”. In particular, Li_{1.5}Al_{0.5}Ge_{1.5} (PO₄)₃ is preferred as the above-mentioned oxide solid electrolyte material. Another example of the compound having a NASHICON type structure is a compound expressed by the following general expression “Li₁₊ₓAlₓTi₂₋ₓ (PO₄)₃ (0≦x≦2)”. In particular, Li_{1.5}Al_{0.5}Ti_{1.5} (PO₄)₃ is preferred as the above-mentioned oxide solid electrolyte material. Other examples of the oxide solid electrolyte material include LiLaTiO (e.g., Li_{0.34}La_{0.51}TiO₃), LiPON (e.g., Li_{2.9}PO_{3.3}N_{0.46}), and LiLaZrO (e.g., Li₇La₃Zr₂O₁₂).

Examples of the shape of the solid electrolyte material include a particulate or a lamella. The average particle diameter (D₅₀) of the solid electrolyte material is preferably within a range of 1 nm to 100 μm, and is more preferably within a range of 10 nm to 30 μm. The amount of the solid electrolyte material contained in the solid electrolyte layer is preferably equal to or larger than 60% by weight, more preferably equal to or larger than 70% by weight and far more preferably equal to or larger than 80% by weight, for example. The solid electrolyte layer may contain a binder, or it may contain only a solid electrolyte material. The thickness of the solid electrolyte layer, although it greatly depends on the configuration of the battery, is preferably within a range of 0.1 μm to 1000 μm, and is more preferably within a range of 1 μm to 100 μm, for example.

(4) Other Members

The solid secondary battery according to the present invention may additionally include a positive electrode current collector for collecting the positive electrode active material layer and a negative electrode current collector for collecting the negative electrode active material layer. Examples of the material used for the positive electrode current collector include SUS, aluminum, nickel, iron, titanium and carbon. Examples of the material used for the negative electrode current collector include SUS, copper, nickel and carbon. Further, a normal type of a battery case of a general solid secondary battery may be used for a battery case of the present invention. Examples of the battery case include a battery case made of SUS.

(5) Solid Secondary Battery

Examples of the solid secondary battery according to the present invention include a lithium solid secondary battery, a sodium solid secondary battery, a potassium solid secondary battery, a magnesium solid secondary battery and a calcium solid secondary battery, out of which the lithium solid secondary battery is the best example. Since the solid secondary battery according to the present invention can be repeatedly charged and discharged, it is useful as a car-mounted battery, for example. Examples of the shape of the solid secondary battery of the present invention include a coin shape, a laminate shape, a cylindrical shape and a rectangular shape. A producing method of the solid secondary battery is not particularly limited if the method is a method such as to allow the above-mentioned solid secondary battery, but the same method as a producing method of a general solid state battery can be used. Examples of the method include the press method, the coating method, the evaporation method and the spraying method.

The present invention is not limited to the above-mentioned embodiments. The above-mentioned embodiments are exemplification, and any is included in the technical scope of the present invention if it has substantially the same constitution as the technical idea described in the claim of the present invention and offers similar operation and effect thereto.

### BRIEF DESCRIPTION OF THE REFERENCE NUMBER

1 Positive electrode active material layer

2 Negative electrode active material layer

3 Solid electrolyte layer

4 Positive electrode current collector

5 Negative electrode current collector

10 Solid secondary battery

12 Switching unit

15 Load

17 Temperature sensor

18 Heater

19 Control unit

20 and 20A Solid secondary battery system

50 Variable resistance

1. A solid secondary battery system comprising:
a solid secondary battery including a positive electrode active material layer, a negative electrode active material layer and a solid electrolyte layer formed between the positive electrode active material layer and the negative electrode active material layer;
a heater for warming the solid secondary battery;
an over-discharge process unit configured to perform over-discharge process of the solid secondary battery; and
a control unit configured to warm the solid secondary battery by means of the heater and/or to make the over-discharge process unit perform the over-discharge process of the solid secondary battery after the warming.

2. The solid secondary battery system according to claim 1,
wherein the heater is connected to the solid secondary battery and warms the solid secondary battery by using electricity of the solid secondary battery.

3. The solid secondary battery system according to claim 2,
wherein the heater functions as the over-discharge process unit, and
wherein the control unit drives the heater to let the heater consume the electricity of the solid secondary battery if voltage of the solid secondary battery becomes smaller than a predetermined voltage.

4. The solid secondary battery system according to claim 2,
wherein the control unit lets the heater consume the electricity of the solid secondary battery, and makes an external short circuit of the solid secondary battery if the heater ceases to work.

5. The solid secondary battery system according to claim 3, wherein the control unit lets the heater consume the electricity of the solid secondary battery, and makes an external short circuit of the solid secondary battery if the heater ceases to work.
